(19) United States
(12) Patent Application Publication
(10) Pub. No.: US 2010/0000042 A1
(43) Pub. Date: Jan. 7, 2010

(54) CHASSIS FOR A MOPPING SYSTEM

(75) Inventors: Klaus-Juergen Fischer, Holzappel (DE); Dieter Paetzold, Nassau (DE)

Correspondence Address: DARBY & DARBY P.C., P.O. BOX 770, Church Street Station, New York, NY, 10008-0770, US

(73) Assignee: Leifheit AG, Nassau/Lahn (DE)

(21) Appl. No.: 12/299,743

(22) PCT Filed: Apr. 25, 2007
(86) PCT No.: PCT/EP07/03627

§ 371 Date: Mar. 2, 2009

(30) Foreign Application Priority Data
May 5, 2006 (DE) 10 2006 021 278.9

(51) Int. Cl. A47L 13/58; B62B 3/00

(52) U.S. Cl. 15/261; 280/47.34; 15/264

(57) ABSTRACT

A chassis for a mopping system is provided wherein the mopping system is retained on the chassis on a mopping system receptacle. The mopping system may include a bucket and/or a wiping cloth press and/or a wiping cloth spinner. The chassis includes a braking device which is adapted to switch the chassis from a release position to a blocking position upon the application of a force to the mopping system receptacle. In the release position, the chassis is rollable and in the blocking position, the chassis is secured against rolling away.

### CROSS REFERENCE TO PRIOR APPLICATIONS

This application is a U.S. National Phase application under 35 U.S.C. §371 of International Application No. PCT/EP2007/003627, filed on Apr. 25, 2007, and claims benefit to German Patent Application No. DE 10 2006 021 278.9, filed on May 5, 2006. The International Application was published in German on Nov. 15, 2007 as WO 2007/128411 under PCT Article 21(2).

### FIELD

The present invention relates to a chassis having a mopping system receptacle for accommodating a mopping system, in particular a mopping system having a bucket and/or a wiping-cloth press and/or a wiping-cloth spinner.

### BACKGROUND

In German Patent Application DE 43 20 454 A1, a mobile cleaning cart is described which has a bucket and a vertical press mounted thereon. The vertical press is lever-actuated and is used for drying the mop covers that had been previously rinsed out in the bucket by a slewing motion. The cleaning cart is supported on free castering wheels and, therefore, has the advantage of being able to be pulled along by the user during cleaning of large surface areas, without much expenditure of force. The disadvantage of the cleaning cart is that it can roll away unintentionally and inconveniently, particularly upon actuation of the vertical press. In the extreme case, this can even cause the bucket to tip away from the cleaning cart or the entire cleaning cart to tip over.

In German Patent Application DE 100 65 375 A1, a cleaning device is described which has a base station on wheels. The cleaning device has a receptacle on the base station into which a hand-held cleaning device is able to be set down. This setting down into the receptacle actuates a first operative connection that is linked to a locking device for one or more wheels. In response to the setting down or setting of the cleaning device into the receptacle, the locking device locks the wheels or releases the same. A disadvantage associated with the cleaning device is that, in order to move the cleaning device further along, the user must either completely set down his/her cleaning unit into the receptacle or that—in the case that the locking device releases the wheels when the cleaning unit is removed—the cleaning device is not secured against rolling away during the critical rinsing-out and drying process.

### SUMMARY

It is an aspect of the present invention to provide a chassis for a mopping system which is preferably automatically secured against rolling away when the user rinses out or dries his/her mopping device and which is otherwise freely movable in order to provide ease of handling.

In an embodiment the present invention provides a chassis for a mopping system. The chassis includes a mopping system receptacle adapted to receive the mopping system and a braking device configured to switch the chassis from a release position to blocking position upon the application of a force to the mopping system receptacle. In the release position, the chassis is rollable and in the blocking position the chassis is secured against rolling.

### BRIEF DESCRIPTION OF THE DRAWINGS

Embodiments of the present invention are schematically illustrated in the drawing and is described below with reference to the figures, elements having essentially equivalent functions being denoted by the same reference numerals. The figures show:

FIG. 1: A chassis according to a first embodiment of the present invention in a schematic representation in the release position;

FIG. 2: A chassis according to the first embodiment of the present invention in the blocking position;

FIG. 3: A chassis according to a second embodiment of the present invention; and

FIG. 4: A chassis according to the second embodiment the present invention in a folded-down position.

### DETAILED DESCRIPTION

An embodiment of the present invention provides a chassis which includes a braking device that switches the chassis from a release position in which the chassis is movable, e.g., rollable, to a blocking position in which the chassis is locked and secured against rolling away in response to the application of a force to the mopping system receptacle.

The chassis according to an embodiment of the present invention has the advantage that it is able to move freely during floor cleaning and be pulled by the user without much expenditure of force. Moreover, it has the advantage of being automatically secured against rolling away and thus against overturning, particularly during drying of the rinsed-out mop cover. This makes it unnecessary for the user operate any further actuating levers, such as additional brake levers or adapters for actuating brake levers or brakes, and makes the chassis easy to manipulate, thereby rendering possible a rapid and efficient functioning.

An embodiment of the chassis according to the present invention provides for the braking device to switch from the release position into the blocking position when the force exceeds a preferably settable, position-changing force. Moreover, it may be provided for the braking device to switch from the blocking position into the release position when the force falls below a preferably settable, position-changing force. Further, the chassis is preferably in the release position when the force is smaller than a preferably settable, position-changing force. The position-changing force is preferably selected in such a way that the braking device is not switched into the blocking position by the weight of a bucket filled with water and by the additional weight of a drying device. Additionally, the position-changing force is preferably set in such a way that the braking device is only switched into the blocking position upon actuation by a mop press and/or when loaded with the additional weight of the mopping device.

The chassis preferably has at least one wheel, and more preferably has at least three wheels. One or more of the wheels may be designed as swivel-type caster wheels. The term ‘wheels’ also refers to rollers, roller wheels, rotationally mounted balls or glides.

In an embodiment, the braking device has at least one braking element, such as a brake block. It may be provided that the braking element for locking the chassis stand with the base on the chassis and/or that it come into contact with at least one wheel of the chassis.

The braking element may be configured on a lever arm. The lever arm is preferably able to swivel in response to force being applied to the mopping system receptacle.

Preferably, the chassis is tiltable from the release position into the blocking position.

In an embodiment, the chassis has at least three wheels that define a rolling platform. In the release position, the chassis preferably stands upright on the wheels of the rolling platform and is thus able to be freely rolled by the user over the surface to be cleaned. Alternatively or additionally, the chassis has a braking platform having at least one braking element, such as a brake block. In the blocking position, it is preferably provided for the chassis to stand upright on the braking platform, respectively on elements of the braking platform.

It may further be provided for at least one wheel, and preferably two wheels, to be both elements of the rolling platform, as well as elements of the braking platform.

In another embodiment, the chassis tilts in response to the application of the force, preferably via the wheels, which are both elements of the rolling platform as well as elements of the braking platform, from the rolling platform onto the braking platform. This variant makes it readily possible to transfer the chassis, together with the mopping system, from the release position to the blocking position. To this end, it may be advantageously provided that the braking platform form an angle with the rolling platform that differs from 180 degrees.

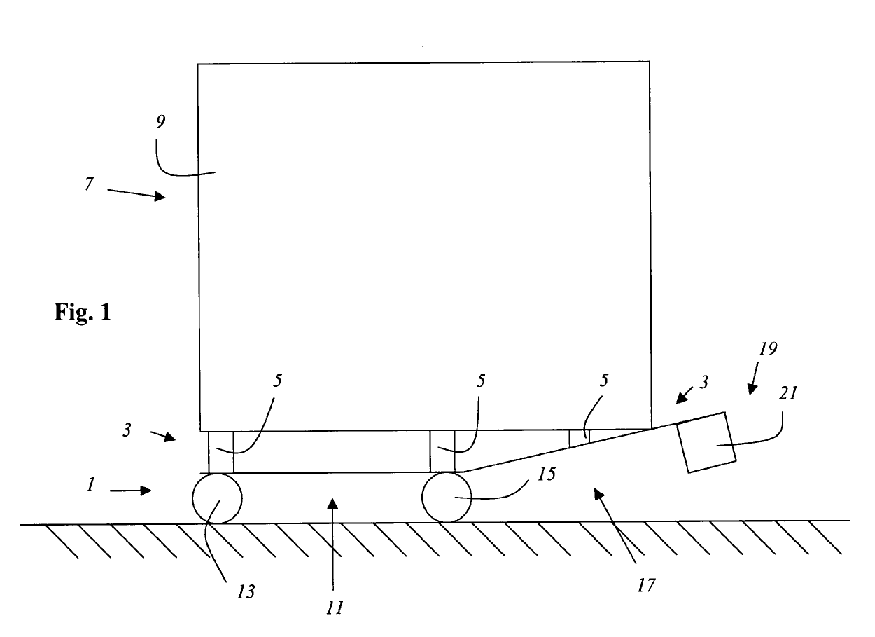

FIG. 1 shows a chassis 1 according to the present invention having a mopping system receptacle 3 which contains a plurality of mounting blocks 5. A mopping system 7 having a bucket 9 rests on mounting blocks 5. In this case, the mopping system may contain a mop press (not shown here). Chassis 1 has a rolling platform 11 having first wheels 13 and second wheels 15. Moreover, the chassis has a braking platform 17 having a braking element 19 which is designed as a brake block 21. In the illustrated release position, chassis 1 stands upright on wheels 13, 15 of rolling platform 11.

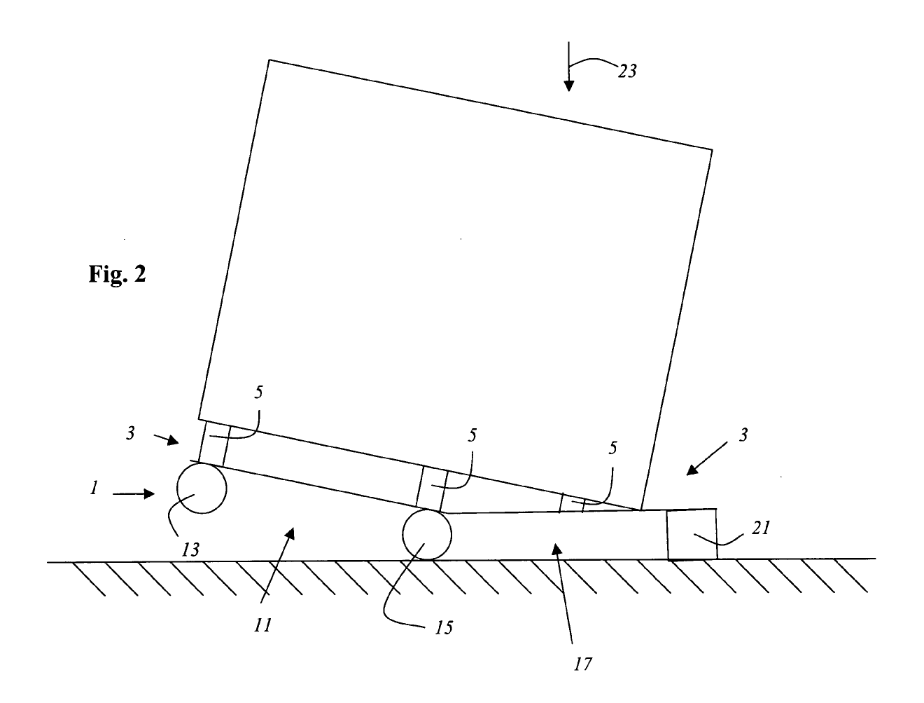

FIG. 2 shows chassis 1 according to the present invention in response to a force 23 greater than the position-changing force being applied to receptacle 3. In response to the application of force 23, chassis 1 is tilted via second wheels 15 onto braking platform 17 and, in this blocking position, is thus secured against rolling away.

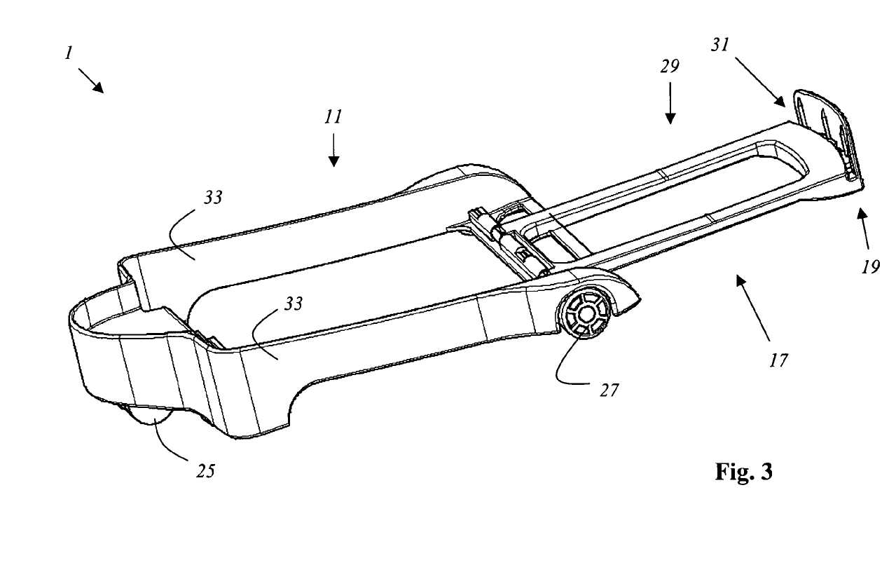

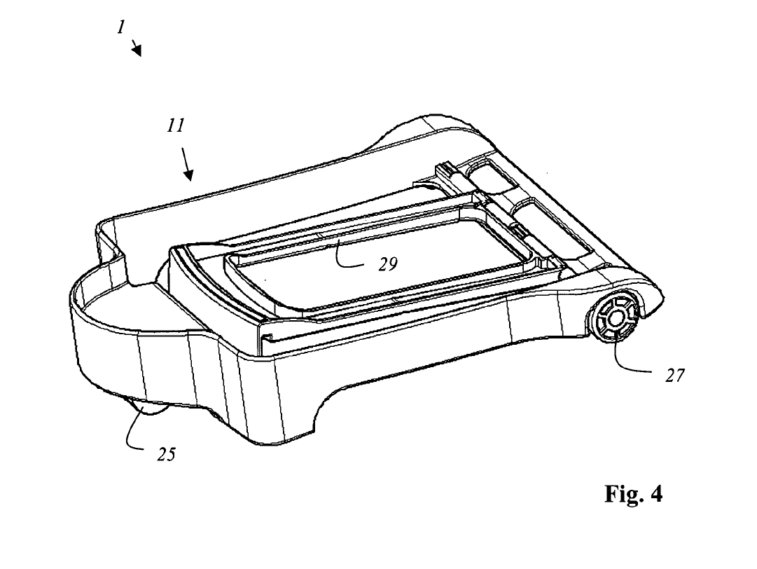

FIG. 3 shows another chassis 1 according to the present invention having a rolling platform 11, a caster wheel 25 and other wheels 27. Braking element 19 is configured on a lever arm 29 which constitutes braking platform 17. Lever arm 29 is joined by articulation, e.g., hinged, to the rolling platform so that it may be folded down, as is shown in FIG. 4. This makes illustrated chassis 1 stowable and compact. In the case of this chassis 1, the mopping system receptacle is formed by a retaining groove 31 and retaining sidewalls 33, in which a cleaning bucket may be securely set. In response to the application of the force to the chassis: the chassis tilts via the other wheels 27 from rolling platform 11 onto braking platform 17; and back again when the force disappears or is reduced in magnitude.

The present invention has been described with reference to particular embodiments. However, it is evident that changes and modifications thereto may be made without departing from the protective scope of the claims set forth in the following.

1-23. (canceled)

24. A chassis for a mopping system, comprising:
a mopping system receptacle adapted to receive the mopping system; and
a braking device figured, upon an application of a force to the mopping system receptacle, to switch the chassis from a release position in which the chassis is rollable to a blocking position in which the chassis is secured against rolling.

25. The chassis according to claim 24, wherein the braking device switches the chassis from the release position to the blocking position when the force exceeds a predetermined position-changing force.

26. The chassis according to claim 25, wherein the predetermined position-changing force is settable.

27. The chassis according to claim 24, wherein the braking device is adapted to switch the chassis back from the blocking position to the release position when the force falls below a predetermined position-changing force.

28. The chassis according to claim 24, wherein the chassis is in the release position when the force is less than a predetermined position-changing force.

29. The chassis according to claim 24, wherein the chassis includes a rolling device having at least one wheel.

30. The chassis according to claim 24, wherein the braking device includes at least one braking element.

31. The chassis according to claim 30, wherein the at least one braking element is a brake block.

32. The chassis according to claim 30, wherein the at least one braking element is configured to come into contact with a floor.

33. The chassis according to claim 30, wherein the chassis includes a rolling device having at least one wheel, and wherein the at least one braking element is adapted to come into contact with the at least one wheel.

34. The chassis according to claim 30, further comprising a lever arm, wherein the at least one braking element is disposed on the lever arm.

35. The chassis according to claim 34, wherein the lever arm is adapted to swivel in response to the force applied to the mopping system receptacle.

36. The chassis according to claim 24, wherein the chassis is adapted to tilt from the release position to the blocking position.

37. The chassis according to claim 24, further comprising a rolling platform including a rolling device, the rolling device including at least two wheels, and wherein the braking device includes a braking platform including at least one braking element.

38. The chassis according to claim 37, wherein the chassis stands upright on the at least two wheels of the rolling platform when in the release position and stands upright on the at least one braking element when in the blocking position.

39. The chassis according to claim 37, wherein the braking platform and the rolling platform include at least one common second wheel.

40. The chassis according to claim 39, wherein the chassis is adapted to tilt from the rolling platform to the braking platform via the at least one second wheel.

41. The chassis according to claim 37, wherein the braking platform is inclined with respect to the rolling platform.

42. The chassis according to claim 24, wherein the mopping system includes at least one of a bucket, a wiping cloth press and a wiping cloth spinner

43. An apparatus for cleaning comprising:
a cleaning system; and
a chassis supporting the cleaning system and including a braking device,
wherein the braking device is adapted to switch the chassis from a release position, in which the chassis is rollable, to a blocking position, in which the chassis is secured against rolling, upon the application of a force to the cleaning system.

44. The apparatus for cleaning according to claim 43, wherein the cleaning system includes a bucket.

45. The apparatus for cleaning according to claim 43, wherein the cleaning system includes a drying device for wiping cloths.

46. The apparatus for cleaning according to claim 43, wherein the cleaning system includes at least one of a wiping cloth press and a wiping cloth spinner.
